(19) United States
(12) Patent Application Publication
(10) Pub. No.: US 2010/0047430 A1
(43) Pub. Date: Feb. 25, 2010

(54) HAIRLINE CRACKED BROWN RICE AND PROCESSING METHOD THEREOF

(76) Inventors: Jerng-Sik Song, Seoul (KR); Chan Woo Song, New York, NY (US); Won-Kyung Song, New York, NY (US)

Correspondence Address: CHRISTOPHER PAUL MITCHELL, 888 16TH ST., NW, SUITE 800, WASHINGTON, DC, 20006, US

(21) Appl. No.: 12/515,888

(22) PCT Filed: Nov. 19, 2007
(86) PCT No.: PCT/KR07/05796

§ 371 Date: May 21, 2009

(30) Foreign Application Priority Data
Nov. 21, 2006 (KR) 10-2006-0114916

(51) Int. Cl. A23L 1/10

(52) U.S. Cl. 426/627; 426/518

(57) ABSTRACT

Hairline-cracked brown rice and a processing method thereof are provided, in which the brown rice is processed at room temperature with a simple method, and the brown rice has good mouth-feel like the polished rice and is easy to be cooked while maintaining its nutrients.

### TECHNICAL FIELD

The present invention relates to brown rice which is easy to be cooked while maintaining its nutrition and a processing method thereof.

### BACKGROUND ART

The brown rice generally has a structure consisting of a bran layer, an internal starch body, and an embryo part that is embryo bud of rice. The starch body, is also referred to as albumen, is mainly comprised of starch particles. The starch body is used as polished rice that is obtained by polishing off the bran layer. The brown rice has a weight ratio of the bran layer 5˜6 wt %, the embryo part 2˜3 wt % and the starch body 92 wt %. Therefore, when the brown rice is polished with a rice-polishing machine, there is a weight loss of approximately 8%, thereby polished rice of 92 wt % is obtained.

Since the bran layer and the embryo part, which are polished off and discarded in the course of polishing the brown rice to make the polished rice, contain fibroid material, vitamin B, inorganic nutrients and the like, it is well known that the brown rice is considered more useful to the health than the polished rice. However, the bran layer contains much fat ingredients, so that it is difficult for water to permeate therethrough. Accordingly the brown rice should be soaked in water for a long time so as to cook the brown rice or should be cooked in a pressure cooker. However, it is inconvenient to soak the brown rice in water for a long time. In addition, the method of cooking the brown rice in the pressure cooker is performed at high temperature, so that the nutrients are destroyed. Further, in case of using such methods, since the bran layer still covers around the starch body as it was even after the cooking, the eater feels more hard and slippery as compared to the cooked polished rice when chewing the cooked brown rice, so that the mouth-feel is considerably degraded.

Various inventions have been suggested for easily eating the brown rice. However, the final price of the processed brown rice should be remarkably increased because lengthy time and many processes are required in order to practice those inventions.

There has been provided e.g., a Korean Patent No. 47740 titled “Processing method of brown rice for easily cooking” in which brown rice and polished rice can be cooked under the same condition, and the mixture of brown rice and polished rice can be easily cooked even at home. However, the processing method comprises the steps of 1) dehydrating the brown rice after soaking it in 25 to 30° C. water for 5 to 6 hours, 2) taking the brown rice out immediately after steaming the same at 100 to 120° C. for 25 to 30 minutes, 3) soaking the same in 25 to 30° C. water for 20 to 25 minutes, 4) first-drying the same at 120° C. for 20 to 30 minutes, 5) second-drying the same at 75 to 85° C. for 50 to 60 minutes, and 6) finally drying the same at 45 to 50° C. for 30 to 40 minutes. In the above method, total six steps are performed under various temperature ranges for long time in order to process the brown rice for easily cooking, so that the above method is very complicated and uneconomical.

Further, there has been provided a Korean Patent No. 247686 titled “Method for germinating brown rice”, which is a method of germinating brown rice so that the germinated brown rice can be easily cooked and can taste soft and savory like the polished rice. The above method comprises the steps of 1) putting unhulled rice in a vessel of salt water in order to select fully grown rice having vigorous germinative power, 2) hulling the selected fully grown rice into brown rice, 3) soaking the brown rice in 12 to 18° C. water for 6 to 10 hours, 4) gradually rising the water temperature up to 20 to 32° C. and then soaking the brown rice in the water for 1 to 8 hours, thereby performing a primary underwater germination, 5) keeping the brown rice, for which the primary underwater germination process was performed, more than 1 cm above the surface of the water and maintaining the same for 2 to 5 hours, thereby performing an air germination process, 6) soaking the brown rice in 20° C. water or in yellow soil-deposited water for 8 to 24 hours, thereby performing an underwater germination process, and then repeating the air germination process and this underwater germination process alternately, and 7) after the germinative phenomenon of air bubble generation is observed, alternately repeating the underwater germination process and the air germination process while maintaining the temperatures of water and atmosphere between 20 and 32° C. until the brown rice shows the predetermined degree of germination. Since the above method needs as many as seven steps that should be performed under various temperatures for many days, it has serious drawbacks that it is very complicated and uneconomical and may destroy the nutrients in the brown rice.

Further, there has been provided a Korean Patent No. 152361 titled “Method of processing soft brown rice” which claims to provide soft brown rice that has increased nutrients, and can be cooked and has good mouth-feel like the polished rice, and can be digested easily. The above method comprises the steps of 1) soaking unhulled rice or brown rice in 30 to 40° C. water for about 36 to 48 hours, thereby inducing the same to be germinated at 39 to 42% moisture content, 2) holding the above germination starting unhulled rice or brown rice at −1 to −2° C. for 1 to 4 days, thereby stopping the germination, 3) taking out the rice held in cold storage and steaming the same at 100 to 105° C. for 25 to 35 minutes, 4) drying the same while leaving the same at room temperature, thereby reducing the moisture content, and 5) introducing the brown rice between two rollers of a brown rice manufacturing apparatus so as to press the same. In the above method, total five steps are performed under various temperature ranges for 3 to 9 days in order to make the brown rice for easily cooking, so thus the above method is also very complicated and uneconomical.

Further, there has been provided a Korean Patent No. 509671 titled “Rupture Modified Brown Rice and Manufacturing Method” which manufactures ruptured brown rice at room temperature with a simple method. The above method is very economical and convenient to use because the cooking method thereof is completely identical to that of the polished rice while the nutrients in the brown rice is maintained as it is, and provides the good mouth-feel like the polished rice. However, the above method has problems in that when the brown rice is fractured into small pieces, it may generate rice powder, thereby reducing yield percentage, and that the ruptured brown rice may be recognized as low-grade products since purchasers may misunderstand the ruptured brown rice as the collection of broken brown rice scraps.

### DISCLOSURE OF INVENTION

### Technical Problem

The present invention has been made to solve the above problems occurring in the prior arts. The objects of the present invention are to provide hairline-cracked brown rice and a processing method thereof, which manufactures the hairline-cracked brown rice at room temperature with a simple method. The hairline-cracked brown rice of the present invention is very economical and convenient to use and has good mouth-feel when chewed, and the cooking method of the hairline-cracked brown rice is completely identical to that of the polished rice while the nutrients in the brown rice is maintained as it is. In particular, the hairline-cracked brown rice prevents the powder generation upon being processed, thereby providing high yield percentage and has good market quality as the whole undivided shape of the brown rice is maintained.

### Technical Solution

In order to accomplish the above objects, there is provided hairline-cracked brown rice, wherein the bran layer thereof covering the starch body is fractured and at least one hairline crack is formed in the starch body.

Further, there is provided a method of processing brown rice comprising the steps of: putting the brown rice on a rubbery material, and pressing the brown rice against the rubbery material with an object of rigid material in order to form a hairline-crack in the brown rice.

### Advantageous Effects

The hairline-cracked brown rice of the present invention can be cooked completely identically to the polished rice without soaking the brown rice in water for a long time or using a pressure cooker because water can easily permeate into the starch body through the hairline crack. Further, since the bran layer of the hairline-cracked brown rice is fractured already, the cooked brown rice does not feel hard and slippery when chewed, so that mouth-feel is good. Further, since all the processes to make the hairline-cracked brown rice are performed at room temperature without using a high temperature method or a germination method, the nutrients contained in the brown rice is still maintained as it is.

Further, since the hairline-cracked brown rice can be easily manufactured, the production cost is considerably low and therefore it can be provided to consumers for economical price. In addition, the hairline-cracked brown rice improves the mouth-feel of the brown rice and the inconvenience upon cooking the brown rice.

In particular, the hairline-cracked brown rice of the present invention can minimize the production of powder upon being processed, thereby increasing yield ratio and can provide improved market value since the complete undivided shape of the brown rice is kept as it is.

### BRIEF DESCRIPTION OF THE DRAWINGS

FIG. 1 is a drawing illustrating the structure of general brown rice.

FIG. 2 is a drawing illustrating brown rice according to an embodiment of the present invention.

### MODE FOR THE INVENTION

Hereinafter, the brown rice according to an embodiment of the present invention and a processing method thereof will be described with reference to accompanying drawings.

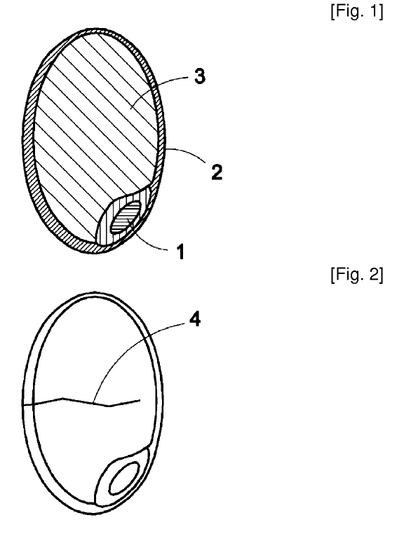

FIG. 1 is a view illustrating the structure of general brown rice, wherein the brown rice includes an embryo part 1, a bran layer 2, and a starch body 3. As shown in FIG. 1, the bran layer 2 covers the starch body 3. Accordingly, for the general brown rice, water is not easy to permeate the starch body 3, so that it is greatly difficult to cook the brown rice compared to the polished rice, of which the bran layer 2 is removed by polishing.

Therefore, the present invention provides brown rice that is processed to have at least one hairline crack. In the hairline-cracked brown rice, the starch body 3 is exposed to outside to make it easy to cook, and powder produced upon processing this brown rice is prevented in contrast with the completely fractured brown rice, thereby improving yield ratio.

FIG. 2 is a drawing illustrating the brown rice according to an embodiment of the present invention, wherein the bran layer 2 is fractured and a hairline crack 4 is formed in the starch body 3. As for the cracked brown rice, water permeates easily into the starch body 3 through the hairline crack 4 by capillary action. Accordingly, since the water can permeate into the starch body 3 easily through the whole crack surface of the cracked brown rice, the cracked brown rice can be cooked in the completely same way as the polished rice.

According to the manufacturing method of the hairline-cracked brown rice, the brown rice is put on a rubbery material which is supported by a rigid material, and is pressed against the rubbery material with an object of rigid material so that the hairline crack 4 is formed thereon.

That is, when the brown rice is put on an elastic rubbery material supported by a rigid material, and is pressed by a rod of rigid material, the elastic rubbery material under the brown rice is pressed by the rod, so that repulsive force of the rubbery material pushes the brown rice upward. Under such state, both ends of the brown rice are pressed upward by the pressed rubbery material. When the pressing force is increased, the bran layer 2 of the brown rice is fractured and the hairline crack 4 is formed in the starch body 3.

In order to form the hairline crack without making the brown rice fractured completely, it would be necessary to adjust the hardness (e.g., Shore hardness) or the thickness of the rubbery material, the pressing force, or the like.

While the invention has been shown and described with reference to certain preferred embodiments thereof, it will be understood by those skilled in the art that various changes in form and details may be made thereto without departing from the spirit and scope of the invention as defined by the appended claims.

### INDUSTRIAL APPLICABILITY

According to the hairline-cracked brown rice and the processing method thereof, there can be provided the brown rice having improved market value.

1. Hairline-cracked brown rice, wherein bran layer covering starch body is fractured and hairline crack is formed in the starch body.

2. A method of processing brown rice comprising the steps of: putting the brown rice on a rubbery material, and pressing the brown rice against the rubbery material with an object of rigid material to form hairline crack in the brown rice.
